(19) United States
(12) Patent Application Publication
(10) Pub. No.: US 2006/0095690 A1
(43) Pub. Date: May 4, 2006

(54) System, method, and storage medium for shared key index space for memory regions

(75) Inventors: David F. Craddock, New Paltz, NY (US); Thomas A. Gregg, Highland, NY (US); Donald W. Schmidt, Stone Ridge, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 10/977,780

(22) Filed: Oct. 29, 2004

(51) Int. Cl. G06F 12/00

(52) U.S. Cl. 711/153; 711/114; 711/206

(57) ABSTRACT

In a logical partitioning (LPAR) environment with InfiniBand™ host channel adapters (HCAs), multiple operating systems share the resources of a physical HCA. A mechanism for efficiently allocating memory regions (or memory windows) to different LPARs is provided, while ensuring that a memory region assigned to one LPAR is not accessible from another LPAR.

### BACKGROUND OF THE INVENTION

1. Field of the Invention

The present invention relates generally to computer and processor architecture, storage management, input/output (I/O) processing, operating systems, and, in particular, to managing adapter resources associated with memory regions shared by multiple operating systems.

2. Description of Related Art

InfiniBand™ (IB) provides a hardware message passing mechanism that can be used for input/output devices (I/O) and interprocess communications (IPC) between general computing nodes. Consumers access IB message passing hardware by posting send/receive messages to send/receive work queues on an IB Channel Adapter (CA). The send/receive work queues (WQ) are assigned to a consumer as a Queue Pair (QP). Consumers retrieve the results of these messages from a Completion Queue (CQ) and through IB send and receive work completions (WC).

The source CA takes care of segmenting outbound messages and sending them to the destination. The destination CA takes care of reassembling inbound messages and placing them in the memory space designated by the destination's consumer. There are two CA types: Host CA and Target CA. The Host Channel Adapter (HCA) is used by general-purpose computing nodes to access the IB fabric. Consumers use IB verbs to access Host CA functions. The software that interprets verbs and directly accesses the CA is known as the Channel Interface (CD).

A logical partition (LPAR) is the division of a computer's processors, memory, and storage into multiple sets of resources so that each set of resources can be operated independently with its own operating system instance and applications.

In a logical partitioning (LPAR) environment with InfiniBand™ host channel adapters (HCAs), multiple operating systems share the resources of a physical HCA. However, the InfiniBand™ Architecture Specification, Release 1.1, does not address the sharing of HCA resources by different operating systems running in an LPAR environment. The IB specification also does not define a mechanism for associating memory regions to a particular operating system and assumes that only a single operating system will have access to the resources of an HCA. There is a need for a mechanism for efficiently allocating memory regions to different LPARs while ensuring that a memory region assigned to one LPAR is not accessible from another LPAR.

There are similar needs for other remote direct memory access (RDMA)-capable adapters, such as RDMA enabled network interface cards (RNICs) and for memory windows as well as memory regions. RNICs use TCP/IP and Ethernet networks, instead of InfiniBand™ networks. On the server side, RNICs have constructs similar to HCAs, such as memory regions and queue pairs. RNICs are different on the link side, such as using Ethernet. A memory window is a portion of a memory region that has been registered with an HCA.

### BRIEF SUMMARY OF THE INVENTION

The present invention is directed to a shared key index space for memory regions associated with RDMA-capable adapters in an LPAR environment that satisfies these needs and others.

One aspect is a method of providing shared key index spaces for memory regions. A group of memory regions is associated to a logical partition (LPAR) using a first portion of a key index. Each memory region is associated with an RDMA-capable adapter. The LPAR is one of at least one LPARs. A single pointer is provided for locating an entry in a protection table to an operating system running in the LPAR. The entry defines characteristics of the group of memory regions.

Another aspect is a system for providing shared key index spaces for memory regions, including a system memory and an adapter. The system memory has a protection table for each logical partition (LPAR). The adapter has a protection table page table. The protection table page table is indexable by a key index to locate an entry in the protection table. The entry defines characteristics of a memory region or a memory window associated with the adapter. The adapter is shared by a number of operating systems running in different LPARs.

Yet another aspect is a data structure for providing shared key index spaces for memory regions, including a key index and a protection table page table. The key index has a protection table index, a page index, and a key instance. The protection table page table has a plurality of rows. Each row has a page pointer, a valid indication, a logical partition (LPAR) identifier (ID), and a memory region control. An entry associated with a memory region is located in a protection table in a system memory by using the key index and the protection table page table. The entry includes characteristics of the memory region. The system memory one or more LPARs, each LPARs running an operating system. The operating systems share a host channel adapter that stores the protection table page table.

A further aspect is a computer-readable medium having instructions stored thereon to perform a method of locating a memory region. A packet is received on a link. The packet includes a key index. An entry in a protection table is located for a particular logical partition (LPAR) by using the key index and a protection table page table. The entry includes characteristics of a memory region.

### BRIEF DESCRIPTION OF THE DRAWINGS

These and other features, aspects, and advantages of the present invention will become better understood with regard to the following description, appended claims, and accompanying drawings, where:

FIG. 1 is a diagram of a distributed computer system in the prior art that is an exemplary operating environment for embodiments of the present invention;

FIG. 2 is a functional block diagram of a host processor node in the prior art that is part of an exemplary operating environment for embodiments of the present invention; and

FIG. 3 is a block diagram of an exemplary system memory and an exemplary host channel adapter (HCA) according to an exemplary system embodiment of the present invention.

### DETAILED DESCRIPTION OF THE INVENTION

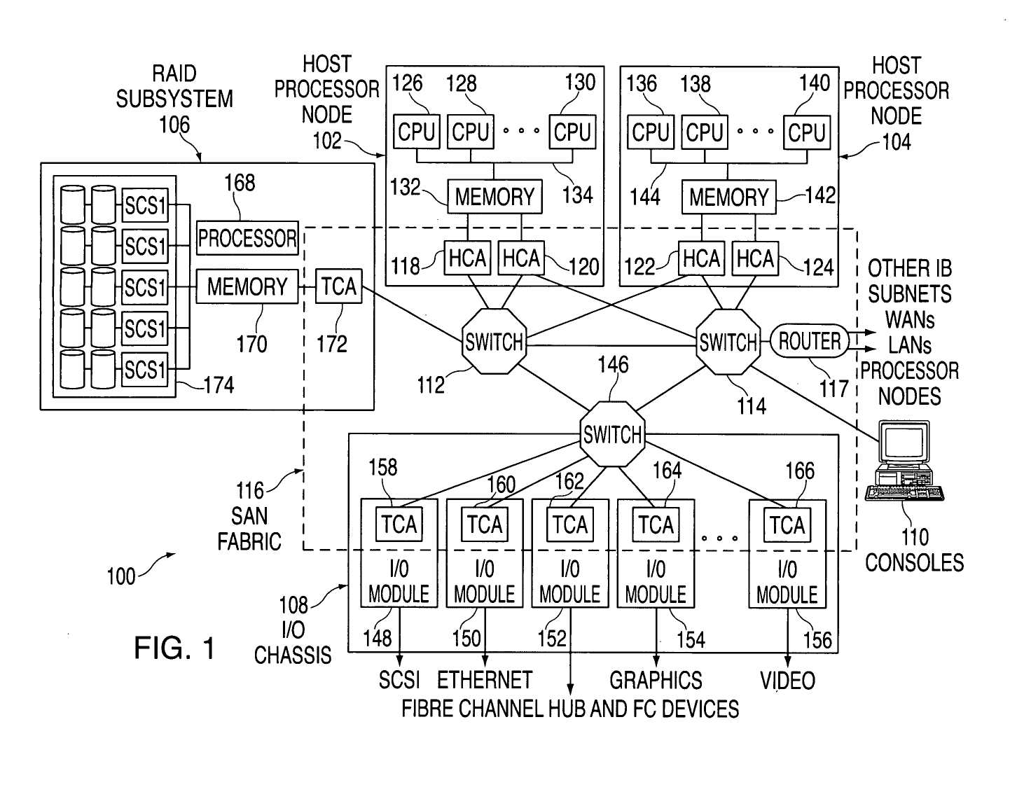

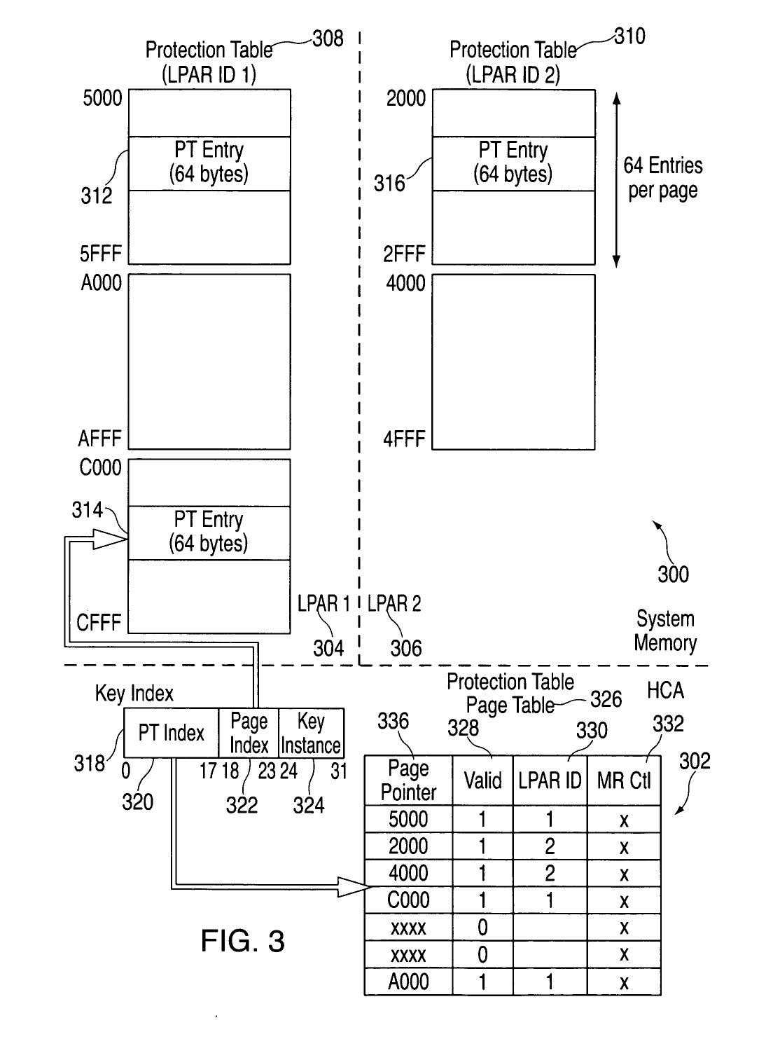

Exemplary embodiments of the present invention provide a shared key index space for memory regions associated with RDMA-capable adapters in an LPAR environment. Exemplary embodiments are preferably implemented in a distributed computing system, such as a prior art system area network (SAN) having end nodes, switches, routers, and links interconnecting these components. FIGS. 1-3 show various parts of an exemplary operating environment for embodiments of the present invention. FIG. 3 shows an exemplary system memory and an exemplary host channel adapter (HCA) according to an exemplary system embodiment of the present invention.

FIG. 1 is a diagram of a distributed computer system. The distributed computer system represented in FIG. 1 takes the form of a system area network (SAN) 100 and is provided merely for illustrative purposes. The exemplary embodiments of the present invention described below can be implemented on computer systems of numerous other types and configurations. For example, computer systems implementing the exemplary embodiments can range from a small server with one processor and a few input/output (I/O) adapters to massively parallel supercomputer systems with hundreds or thousands of processors and thousands of I/O adapters.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an end node, which is herein defined to be a device that originates or finally consumes messages or frames in SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the frame through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low-latency in a secure, remotely managed environment. End nodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as end nodes, switches, or routers. Example suitable links include, but are not limited to, copper cables, optical cables, and printed circuit copper traces on backplanes and printed circuit boards.

For reliable service types, end nodes, such as host processor end nodes and I/O adapter end nodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 116. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communication (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers. The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel arbitrated loop (FC-AL) devices for I/O module 152; an Ethernet adapter card for I/O module 150; a graphics adapter card for I/O module 154; and a video adapter card for I/O module 156. Any known type of adapter card can be implemented. I/O adapters also include a switch in the I/O adapter to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among them or communicate with any or all of the processor nodes in distributed computer systems. With an I/O adapter attached to the SAN 100 the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

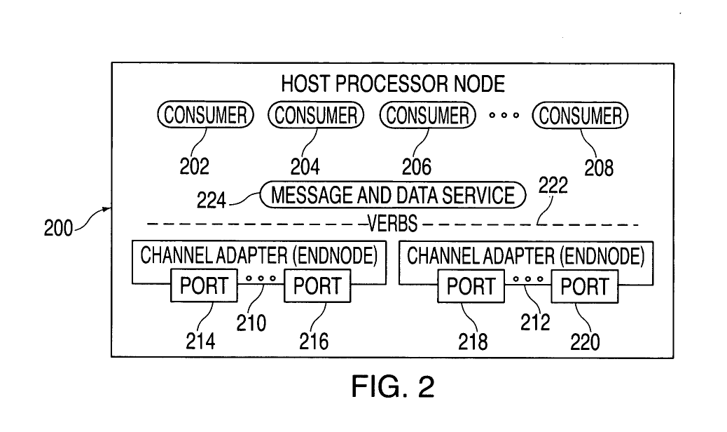

Turning next to FIG. 2, a functional block diagram of a host processor node in the prior art is depicted. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality of a host channel adapter through its programming interface. Basically, this interface defines the behavior of the host. Additionally, host process node 200 includes a message and data service 224, which is a higher-level interface than the verb layer and is used to process messages and data received through channel adapter 210 and channel adapter 212. Message and data service 224 provides an interface to consumers 202-208 to process messages and other data.

FIG. 3 shows an exemplary system memory 300 and an exemplary host channel adapter (HCA) 302 according to an exemplary system embodiment of the present invention. The system memory 300 is shown above the dashed horizontal line, while the HCA 302 is shown below the dashed horizontal line. The system memory 300 is divided into two logical partitions, LPAR 1 304 (on the left) and LPAR 2 306 (on the right) by a dashed vertical line. These two partitions each have protection tables 308, 310.

Embodiments of the present invention allocate portions of a key index space to different LPARs. In this way, operating systems running in different LPARs have the ability to share the resources of the HCA 302 hardware. Memory regions and windows associated with a specific LPAR prevent access from a different LPAR. The allocation of the key index space minimizes the hardware requirements in the HCA 302, while allowing flexibility in allocation of memory regions by the operating system and, at the same time, allowing scaling to large numbers of operating systems, such as may occur in a virtual machine (VM) environment.

The key index space is accessed by a key index. A key 318 is used to reference a memory region or memory window, which defines the access rights and address translation properties for a portion of system memory. In RNIC terminology, key indexes are called storage tags (STags). In the InfiniBand™ specification, key indexes are called R_Keys and L_Keys. An R_Key is a remote key, while an L_Key is a local key.

The protection table page table 326 is used to locate entries in the protection tables 308, 310 in system memory 300. Protection table entries define the characteristics of a memory region or a memory window. These characteristics include length, starting address, access rights, and references to address translation tables. Address translation tables are used by the HCA 302 to convert contiguous virtual addresses into the real addresses of pages that make up the memory region.

The protection tables 308, 310 are stored in system memory to allow scalability to large numbers of regions, while using known techniques to manage the memory required for the tables themselves. The HCA 302 needs to be able to access the protection tables 308, 310 and, thus, needs pointers to the pages that make up the exemplary protection tables 308, 310 shown in FIG. 3.

Memory regions are grouped in the protection tables and the protection table page tables. Each entry in the protection table page table defines the characteristics of a group of memory regions or memory windows. Each group of memory regions or windows is associated with a single LPAR, so that only a single LPAR identifier (ID) and a single page pointer need to be stored in the HCA 302 hardware for each group. In the exemplary system embodiment in FIG. 3, two entries 312, 314 are shown in the protection table 308 in LPAR_1 304. One entry 316 is shown in the protection table 310 in LPAR_2 306. In an exemplary embodiment, there are 64 possible entries per page. Each entry occupies 64 bytes and each page is 4K. A 4K page has 4×1024=4096 bytes. Each page holds 64 entries, since 4096/64=64. Protection table 308 in LPAR 1 304 has 4K pages, e.g., x′C000′−x′CFFF′=x′1000′=4096 bytes=4K.

The memory regions are grouped by giving a block of, for example, 64 memory regions, which equates to 64 of the protection table entries to one LPAR and another block to another LPAR. This scales and is dynamic so that if one LPAR wants more than 64, another one of the pages can be given. Preferably, the amount of information stored on the HCA 302 is minimized but, at the same time, by storing information in system memory 300, the system has large scalability, such as tens of thousands of memory regions.

Each memory region is registered with the HCA 302 so that the HCA 302 knows it characteristics, such as starting address, size, access rights, and other characteristics. For a memory window, its parent memory region is used to do an address translation. Suppose a packet is received on an InfiniBand™ link and the packet includes an R_Key (key 318). The HCA 302 uses the key 318 to index into the protection table page table 326 to access an entry for a memory region (or window) in a protection table 308, 310. Suppose there were 64,000 memory regions supported by a server. Because, it would be difficult to store the information for all of the memory regions in the HCA 302, some of the information is stored in system memory 300. Preferably, the amount of information stored in the HCA 302 is minimized by using the key 318 to split the index into two parts.

The key index space is divided to allow efficient lookups by the HCA 302 hardware. The key 318 includes a protection table (PT) index 320, a page index 322, and a key instance 324, in the exemplary system embodiment shown in FIG. 3. The PT index 320 points to a specific protection table entry that defines a specific group of memory regions. The page index 322 finds the location of an entry within a page. The key instance 324 is used to validate a particular instance of a memory region so that the same protection table entry 312, 314 may be re-used when a memory region is successively deregistered and registered. For example, suppose an operating system registers one of the memory regions and then de-registers it so that another application can reuse that same memory region, using the same PT index 320. In this case, it is preferable to change the key instance 324 value so that an application that has an old copy will not attempt to use it after it is registered to another application. Thus, the key instance 324 prevents access by old users. Other embodiments may use virtual addresses rather than the key 318.

The protection table page table 326 includes rows corresponding to a plurality of key indexes 318. In each row, the protection table page table 326 provides a page pointer 336, a valid indication 328, an LPAR ID 330 and a memory region control (MR Ctl) 332.

In the protection table page table 326, the page pointer 336 is the address of a page in a protection table 308, 310. In this example, the page pointer points to a 4K-page block of memory that contains multiple protection table entries. Other embodiments may follow whatever size pages of memory are most natural. In this example, the protection table entry is 64 bytes so that 64 entries fit in a 4K page. In FIG. 3, protection table 308 in LPAR 1 304 has pages starting at addresses x′5000′, x′A000′, and x′C000′ and protection table 310 in LPAR 2 306 has pages starting at addresses x′2000′ and x′4000′. There is a page pointer 336 in the protection table page table 326 for each of these addresses in different rows.

In the protection table page table 326, the valid indication 328 indicates whether the row is valid. In the example shown in FIG. 3, the two rows having page pointer 336 values of “xxxx” (invalid) and blank (invalid) LPAR IDs 330 have valid indication values of “0” (invalid). Initially, after power-up, all the rows are invalid. The valid indication 328 protects against attempted use of information in an invalid row. Preferably, one bit is used for the valid indication for each memory region to minimize resources on the HCA 302.

In the protection table page table 326, the LPAR ID 330 identifies the LPAR containing the protection table 308, 310 having the entry pointed to by the page pointer 336. In FIG. 3, for example, the PT index 320 indexes the protection table page table 326 at the fourth row. In the fourth row, the page pointer 336 is x′C000′ and the LPAR ID is 1. Thus, the entry is located in the protection table 308 in LPAR 1 in the page starting at x′C000′ offset by the page index 322 in the key 318, which is entry 314.

The LPAR ID 330 is used by the hardware to verify that, for example, a queue pair in one LPAR is not trying to access a region in a different LPAR. An entry in the protection table page table 326 associated with a memory region needs to be associated with an LPAR so that a queue pair (QP) wishing to access this memory region can be checked by the HCA 302 hardware to ensure that the QP and the memory region belong to the same LPAR. If they do not belong to the same LPAR, the HCA 302 will disallow access.

The LPAR ID 330 is associated with a group of memory regions by a hypervisor. When the first memory region is requested by the operating system, the hypervisor allocates a group of memory regions to the operating system and writes the LPAR ID 330 for that group in the HCA 302 hardware. The group is identified to the operating system by the PT index 320 in the key 318. The page index 322 is managed by the operating system in this example. The operating system can register up to 64 memory regions without further intervention by the hypervisor.

In the protection table page table 326, the memory region control 332 is a group of bits with one valid indication bit for each memory region in a group. The memory region control provides the ability to register and deregister individual memory regions with in a group. One bit is used for each memory region to indicate whether it is registered or deregistered. This same bit can be used for memory windows to indicate whether the window is allocated or deallocated. This bit is written by the operating system to indicate to the HCA 302 hardware whether the region is registered or deregistered and the HCA 302 hardware uses this to determine whether access should be allowed to this memory region. In order to synchronize the operating system with the HCA 302 hardware when this bit is written, an acknowledgment is needed to be provided by the HCA 302 hardware that any outstanding accesses are completed before the deregistration process may complete. Other control information is on a group basis, such as page pointer 336 and LPAR ID 330, which are shared across the group.

To illustrate an exemplary method of operation of the exemplary system embodiment shown in FIG. 3, suppose an RDMA write packet is received by the HCA 302. Within the packet header of the RDMA packet is an R_KEY (key 318) that identifies a memory region where data will be written. The HCA 302 examines the key 318 and takes bits 0-17 (PT index 320) of the key 318 to find a row in the protection table page table 326. Suppose, the row was the one with page pointer x′C000′, as shown by the arrow in FIG. 3.

First, the HCA 302 checks that the row is valid and, here, it is (1). Next, the HCA 302 takes bits 18-23 (page index 322) of the key 318 and uses it to index into the memory region control 332 to locate the bit that corresponds to the specific memory region where data will be written and checks that the bit is valid (1). Here, it is valid. Before fetching the page table entry 314, the HCA 302 examines the LPAR ID 330. Here LPAR ID=1. The HCA 302 compares the LPAR ID 330 with the LPAR ID that is stored in the queue pair context that this RDMA packet is targeting. The HCA 302 uses the page pointer 336 as a base address and the page index 322 as an offset to fetch the page table entry 314 in the protection table 308 in LPAR 1 304.

One of the other fields in the RDMA packet header is a queue pair number. The HCA 302 uses the queue pair number to locate the queue pair that this transfer will occur on. The HCA 302 checks that the LPAR ID for the queue pair matches the LPAR ID for the memory region. If they do not match, the access is not allowed. If they do match, the PT entry 314 is fetched.

Another exemplary embodiment is firmware that initializes or loads entries into the protection table page table 326. The firmware knows the location, layout, and contents of the protection table page table 326. Suppose the operating system has an application that needs to register a memory region. First, the operating system sends a request to hypervisor firmware, which is firmware that controls access by the LPARs. When the hypervisor receives the request, the hypervisor determines which LPAR the operating system is running in. Then, the hypervisor sets up an entry in the protection table page table 326 in the HCA 302 that is available to be allocated to the operating system. The entry has a valid bit 326 set to valid (1), the LPAR ID 330 is set to be the one where the operating system is running, all 64 bits of the memory region control 332 are set to zero, (since none of the memory regions are registered yet), and the page pointer 336 value is obtained by translating the virtual address from the operating system to a physical address and stored. Then, the hypervisor returns the group of keys 318, in response to the request.

At this point, the operating system owns and can use the group of 64 keys 318. For example, the operating system can register one of the memory regions. Suppose the memory region in the first position starting at x′C000′ is registered and the values in the protection table entry 312 are set up and, in addition, the bit in the memory region control 332 that corresponds to that first position in the memory region is set to valid (1). After registration, initialization is complete and software can start using the keys 318 for transfers by the HCA 302 into or out of that memory region.

These mechanisms can also apply in a case where a send queue or receive queue are being accessed, but there is a distinction between an R_Key and an L_Key 318. An L_Key is used when a local access is being done. For example, an L_Key is used in a work queue element that software places on either a send queue or a receive queue. That work queue element has a data descriptor that defines the location in memory of the message to be sent or where the received message is to be placed. The data descriptor includes a virtual address, a length, and an L_Key. The HCA 302 uses the L_Key in a similar fashion to the example of the RDMA write packet above to fetch or store the information in a memory region where data will be moved from or to. There are two types of access, the remote access (e.g., receiving an RDMA packet) that use an R_Key 318 and local accesses (e.g., placing a work request on a send or receive queue) that use an L_Key 318. Lookups are efficient with the R_Key/L_Key division, because it is a densely packed contiguous space, which makes it easy to locate the entry as opposed to other options where hashing may be required in sparsely packed space.

Exemplary embodiments of the present invention have many advantages. Great flexibility is provided with respect to the number of memory regions or memory windows that may be associated with a particular LPAR, while minimizing the number of hardware resources needed to manage these entities. In a high-end server environment, an HCA may need to support tens of thousands of memory regions. A simplistic approach would be to provide a fixed allocation of memory regions to each LPAR. This would require a significant amount of HCA resources in order to support tens or possibly hundreds of thousands of memory regions. By contrast, the flexibility of assigning groups of memory regions to individual LPARs dynamically where needed, does not waste the resources of the HCA 302. Consequently, embodiments of the present invention group the memory regions such that a group of protection table page table entries occupies a full page in the protection table page table and the entire group is associated with one LPAR. The grouping of memory regions allows this flexibility while at the same time minimizes the resources needed in the HCA to manage and control the association with an LPAR. Thus, efficient allocation of memory region resources across LPARs is achieved or, more generally, virtualizing resources. It is efficient in terms of minimizing HCA 302 resources and firmware resources.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, functionality may be split differently between the hypervisor, firmware, software applications and operating systems. Exemplary embodiments are applicable to memory windows as well as memory regions and to RNICs as well as IB HCAs. Exemplary embodiments are applicable to any kind of computing devices, including IBM servers and any VM environment. Embodiments may be applied in VM environments in addition to LPAR environments. For example, each VM guest receives a group of memory regions, such as a block of 64. Embodiments may be applied for RNICs. For RNICs, storage tags are used instead of R_Keys/L_Keys 318 and operate similarly. Furthermore, various components may be implemented in hardware, software, or firmware or any combination thereof. Finally, many modifications may be made to adapt a particular situation or material to the teachings of the invention without departing from the essential scope thereof. Therefore, it is intended that the invention is not to be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of providing shared key index spaces for memory regions, comprising:
associating a group of memory regions to a logical partition (LPAR) using a first portion of a key index, each memory region being associated with an RDMA-capable adapter, the LPAR being one of at least one LPARs; and
providing a single pointer for locating an entry in a protection table to an operating system running in the LPAR, the entry defining characteristics of the memory region.

2. The method of claim 1, further comprising:
receiving a request from the operating system for a group of memory regions;
determining which LPAR the operating system is running in;
initializing the entry in a protection table page table;
returning a group of keys.

3. The method of claim 1, further comprising:
registering a memory region in the group of memory regions with the RDMA-capable adapter.

4. The method of claim 1, further comprising:
allocating a memory region within the group to a consumer process by the operating system.

5. A system for providing shared key index spaces for memory regions, comprising:
a system memory having a protection table for each logical partition (LPAR);
an adapter having a protection table page table, the protection table page table being indexable by a key index to locate an entry in the protection table, the entry defining characteristics of a memory region or a memory window associated with the adapter;
wherein the adapter is shared by a plurality of operating systems running in different LPARs.

6. The system of claim 5, wherein the key index includes a page table index, a page index, and a key instance.

7. The system of claim 5, wherein the entries include a page pointer, a valid indication, a LPAR identifier, and a memory region control.

8. The system of claim 5, wherein the adapter is a host channel adapter.

9. The system of claim 5, wherein the adapter is a RDMA enabled network interface card (RNIC).

10. The system of claim 5, wherein the characteristics include one of more of the following: length, starting address, access rights, and a reference to at least one address translation table.

11. The system of claim 5, wherein the protection table has 4K pages and each entry occupies 64 bytes so that each page holds 64 entries.

12. The system of claim 5, wherein the adapter provides a single pointer to a group of memory regions to one of the operating systems upon request.

13. A data structure for providing shared key index spaces for memory regions, comprising:
a key index having a protection table index, a page index, and a key instance; and
a protection table page table having a plurality of rows, each of the rows having a page pointer, a valid indication, a logical partition (LPAR) identifier (ID), and a memory region control;
wherein an entry associated with a memory region is located in a protection table in a system memory by using the key index and the protection table page table, the entry including characteristics of the memory region, the system memory having at least one LPARs, each LPARs running an operating system, the operating systems sharing a host channel adapter, the host channel adapter storing the protection table page table.

14. A computer-readable medium having instructions stored thereon to perform a method of locating a memory region, the method comprising:
receiving a packet on a link, the packet including a key index; and
locating an entry in a protection table for a particular logical partition (LPAR) by using the key index and a protection table page table, the entry including characteristics of a memory region.
